(19) United States
(12) Patent Application Publication
(10) Pub. No.: US 2002/0095794 A1
(43) Pub. Date: Jul. 25, 2002

(54) Motorized grass shear device

(76) Inventor: Kuo Chen Liu, Taichung (TW)

Correspondence Address: Kuo Chen Liu, P.O. Box 63-99, Taichung, 406, TW

(21) Appl. No.: 09/767,233

(22) Filed: Jan. 19, 2001

(51) Int. Cl. B26B 19/02

(52) U.S. Cl. 30/219; 30/216

(57) ABSTRACT

A shear device includes one or more fixed blades secured to the front portion, one or more cutter blade coupled to a lever and moved relative to the fixed blade in a shearing action by the lever. A cam member is rotatably received in the housing and engaged with the lever, and a motor coupled to the cam member for rotating the cam member to move the lever in a reciprocating action and to move the cutter blade relative to the fixed blade in the shearing action. The cam member includes a radially outer peripheral portion slidably received in a notch of the lever.

### BACKGROUND OF THE INVENTION

1. Field of the Invention

The present invention relates to a shear device, and more particularly to a motorized grass shear device.

2. Description of the Prior Art

Typical grass shear devices may be motorized and may include one or more blades movable relative to the other blades for cutting or shearing purposes, and includes a complicated coupling mechanism for coupling the blades to a motor or the like. The coupling mechanism normally includes a number of gears and pinions and pulleys or the like that may not be easily assembled.

The present invention has arisen to mitigate and/or obviate the afore-described disadvantages of the conventional grass shear devices.

### SUMMARY OF THE INVENTION

The primary objective of the present invention is to provide a shear device, such as a grass shear device including a greatly simplified configuration for facilitating the manufacturing and the assembling of the shear device.

In accordance with one aspect of the invention, there is provided a shear device comprising a housing including a front portion, at least one fixed blade secured to the front portion of the housing, at least one cutter blade, a lever pivotally coupled to the cutter blade for moving the cutter blade relative to the fixed blade in a shearing action, a cam member rotatably received in the housing and engaged with the lever, and means for rotating the cam member to move the lever in a reciprocating action and to move the cutter blade relative to the fixed blade in the shearing action. The cam member includes a solid structure and includes a greatly simplified configuration for cam member to be easily manufactured and assembled.

The front portion of the housing includes a channel formed therein for slidably receiving the lever.

The cutter blade includes a middle portion pivotally secured to the fixed blade with a pivot axle, and includes a first end pivotally secured to the lever with a pivot pin, for allowing the cutter blade to be moved relative to the fixed blade in the shearing action.

The lever includes a first end slidably received in the front portion of the housing and having a notch formed therein, the cam member includes a radially outer peripheral portion slidably received in the notch of the lever for moving the lever forward and rearward when the cam member is rotated relative to the housing.

The cam member includes a forward extending portion and a rearward extending portion formed in the radially outer peripheral portion of the cam member and slidably received in the notch of the lever for moving the lever in the forward and rearward reciprocating action and for moving the cutter blade relative to the fixed blade in a shearing action.

The rotating means includes a motor received in the housing and coupled to the cam member, preferably with a reduction gearing device, for rotating the cam member relative to the housing.

The housing includes a shaft rotatably provided therein and coupled to the motor for being rotated by the motor, the cam member is secured on the shaft and preferably includes a hub secured onto the shaft for being driven and rotated by the motor.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a cross sectional view of a shear device in accordance with the present invention;

FIG. 2 is a plane view showing a cam member of the shear device; and

FIGS. 3 and 4 are cross sectional views similar to FIG. 1, illustrating the operation of the shear device.

### DETAILED DESCRIPTION OF THE PREFERRED EMBODIMENT

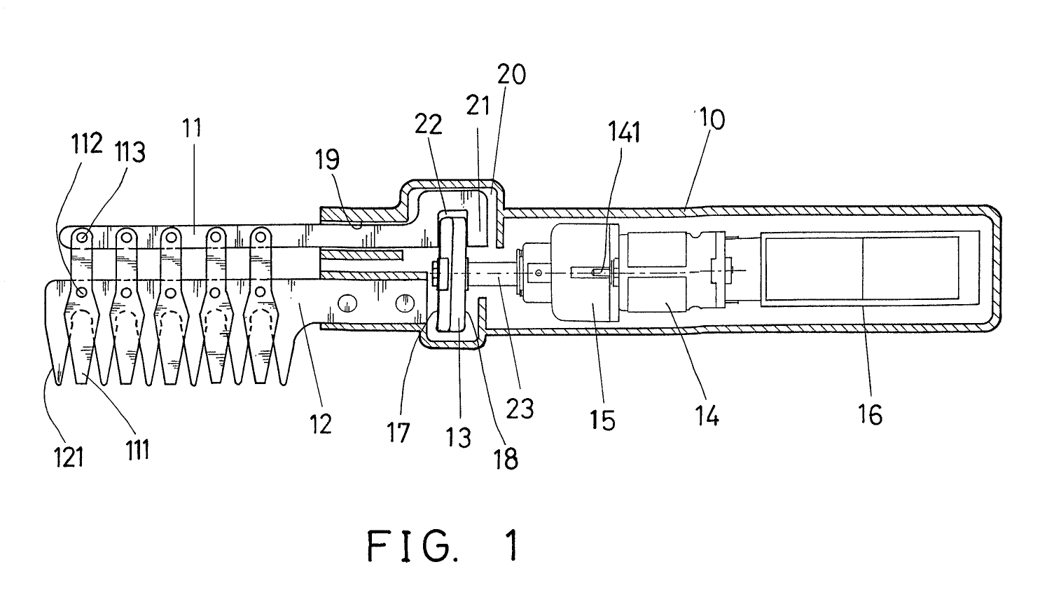

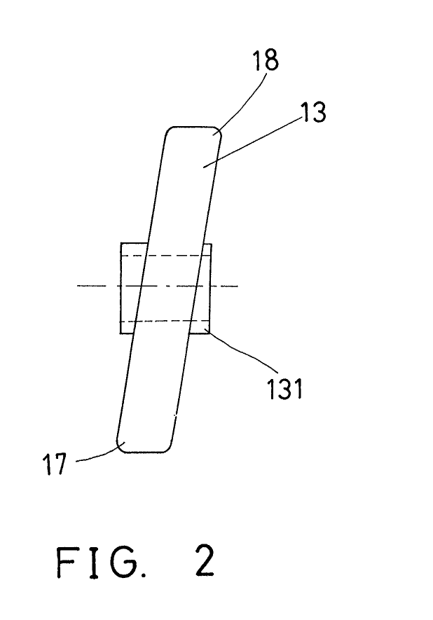

Referring to the drawings, and initially to FIGS. 1 and 2, a shear device in accordance with the present invention may be a grass shear device, and comprises a handle or a housing 10, and an arm 12 secured to the front portion of the housing 10 and extended outward of the housing 10 and including one or more fixed blades 121 extended or dependent downward therefrom. The housing 10 includes a channel 19 and a chamber 20 formed in the front portion thereof. A lever 11 is slidably received in the channel 19 of the housing 10 and includes a block or enlarged head 21 formed or provided on one end thereof and slidably received in the chamber 20 of the housing 10. The head 21 includes a notch 22 formed therein and preferably facing downward or facing radially inward of the housing 10.

One or more cutter blades 111 each includes a middle portion pivotally secured to the arm 12 with a pivot axle 112, and each includes one end pivotally secured to the lever 11 with a pivot pin 113, such that the cutter blades 111 may be moved relative to the fixed blades 121 in order to conduct cutting or shearing operation when the lever 11 is moved in a forward and rearward reciprocating action. A motor 14 is received in the housing 10, one or more batteries 16 are also received in the housing 10 and coupled to the motor 14 for energizing the motor 14. A reduction gearing device 15 is also received in the housing 10 and coupled to the motor 14 for reducing the rotational speed of the spindle 141 of the motor 14, and includes a shaft 23 extended forward from the reduction gearing device 15.

The shear device in accordance with the present invention provides and includes a cam member 13 having a hub 131 secured to the center thereof for receiving the shaft 23 and for securing to the shaft 23 with fasteners or the like, and for allowing the cam member 13 to be rotated by the motor 14 directly or via the reduction gearing device 15. The cam member 13 preferably includes a circular shape having a forward extending portion 17 and a rearward extending portion 18, as shown in FIGS. 2-4, formed in the radially outer peripheral portion thereof and slidably received in the notch 22 of the lever 11, such that the lever 11 may be forced and actuated to move forward and rearward in the reciprocating action when the cam member 13 is rotated by the motor 14.

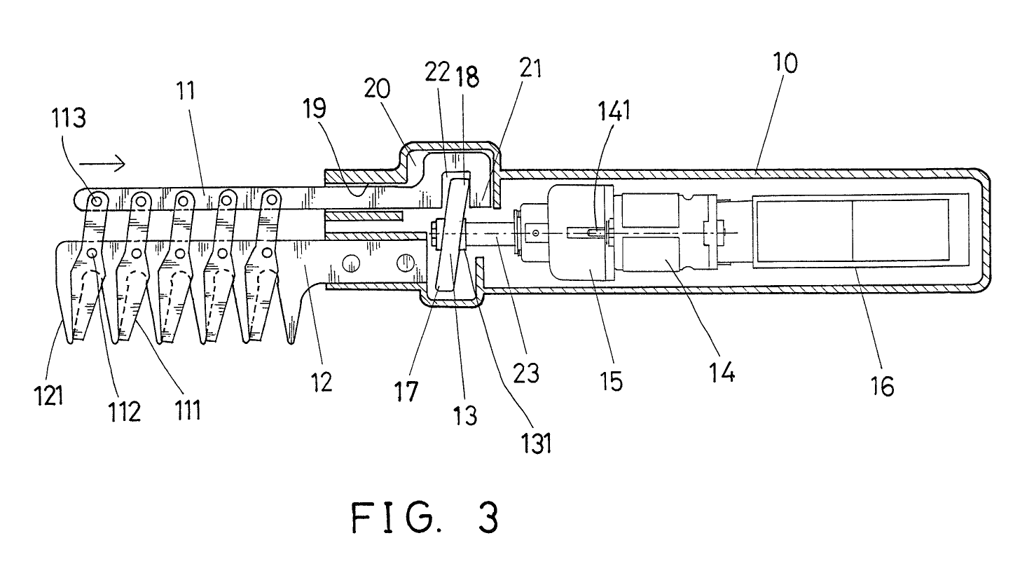

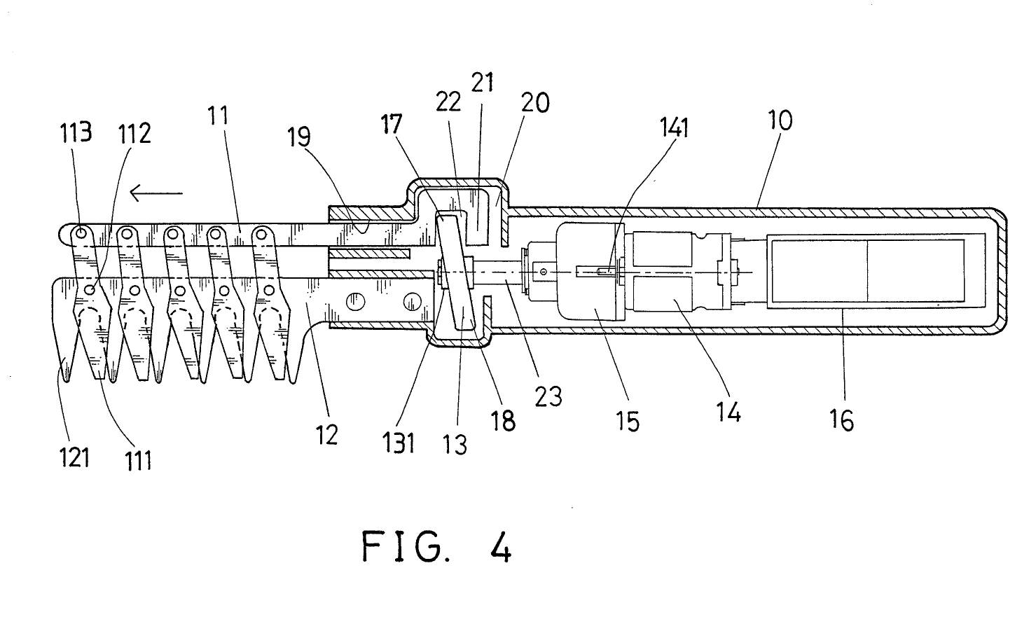

In operation, as shown in FIGS. 3 and 4, the cutter blades 111 may be forced to move in a shear action relative to the fixed blades 121 by the lever 11 when the lever 11 is forced and actuated forward and rearward in the reciprocating action by the sliding engagement of the radially outer peripheral portion of the cam member 13 in the notch 22 of the lever 11, when the cam member 13 is rotated by the motor 14. The lever 11 may thus be easily moved in the reciprocating action by the motor 14 via the cam member 13 which includes a greatly simplified configuration that may be easily manufactured and assembled to the shaft 25 of the reduction gearing device 15.

Accordingly, the shear device in accordance with the present invention includes a greatly simplified configuration for facilitating the manufacturing and the assembling of the shear device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A shear device comprising:
a housing including a front portion,
at least one fixed blade secured to said front portion of said housing,
at least one cutter blade,
a lever pivotally coupled to said at least one cutter blade for moving said at least one cutter blade relative to said at least one fixed blade in a shearing action,
a cam member rotatably received in said housing and engaged with said lever, and
means for rotating said cam member to move said lever in a reciprocating action and to move said at least one cutter blade relative to said at least one fixed blade in the shearing action.

2. The shear device according to claim 1, wherein said front portion of said housing includes a channel formed therein for slidably receiving said lever.

3. The shear device according to claim 1, wherein said at least one cutter blade includes a middle portion pivotally secured to said at least one fixed blade with a pivot axle, and includes a first end pivotally secured to said lever with a pivot pin, for allowing said at least one cutter blade to be moved relative to said at least one fixed blade in the shearing action.

4. The shear device according to claim 1, wherein said lever includes a first end slidably received in said front portion of said housing and having a notch formed therein, said cam member includes a radially outer peripheral portion slidably received in said notch of said lever.

5. The shear device according to claim 4, wherein said cam member includes a forward extending portion and a rearward extending portion formed in said radially outer peripheral portion of said cam member and slidably received in said notch of said lever.

6. The shear device according to claim 1, wherein said rotating means includes a motor received in said housing and coupled to said cam member for rotating said cam member relative to said housing.

7. The shear device according to claim 6, wherein said housing includes a shaft rotatably provided therein and coupled to said motor for being rotated by said motor, said cam member is secured on said shaft for being driven and rotated by said motor.
